(19) United States
(12) Patent Application Publication
(10) Pub. No.: US 2026/0368563 A1
(43) Pub. Date: Nov. 19, 2026

(54) STATE-PRESERVING INTERRUPTION OF IN-PROGRESS INFERENCE FOR PHYSICAL ARTIFICIAL INTELLIGENCE MISSION AND ACTION CONTROL

(71) Applicant: Dorian Cartwright, San Jose, CA (US)

(72) Inventor: Dorian Cartwright, San Jose, CA (US)

(21) Appl. No.: 19/753,100

(22) Filed: Jul. 24, 2026

Related U.S. Application Data
(63) Continuation-in-part of application No. 19/664,886, filed on Apr. 30, 2026.

(51) Int. Cl. G06N 5/04; G06N 5/022

(52) U.S. Cl. CPC G06N 5/04; G06N 5/022

(57) ABSTRACT

A physical artificial intelligence system receives a verbal, gesture, text command or other interruption during in-progress inference for a robot mission or candidate physical action. An inference-interruption controller generates an updated branch context, preserves unaffected inference state, and selectively updates affected state without restarting inference. The resulting inference modifies a mission, route, trajectory, manipulation plan, or candidate action before actuator execution. The system may identify an interrupt-safe boundary, preserve execution metadata, revise a predicted future, revoke stale action authority, and validate an updated action before release.

### CROSS-REFERENCE TO RELATED APPLICATION

This application is a continuation-in-part of commonly owned U.S. patent application Ser. No. 19/664,886, filed Apr. 30, 2026, by Dorian Cartwright, and entitled “DYNAMIC EXECUTION BRANCHING FOR IN-FLIGHT GENERATIVE VIDEO INFERENCE IN A NEURAL PROCESSING UNIT,” the entire disclosure of which is incorporated herein by reference.

### FIELD OF THE INVENTION

The present disclosure relates generally to computers, robotics, and physical artificial intelligence, and more specifically, to modifying the robot mission or candidate physical action based on the updated inference from inference interruptions.

### BACKGROUND

Robots increasingly use artificial intelligence models to perceive physical environments, understand human instructions, generate missions, plan actions, predict physical outcomes, and control actuators. Such robots may include mobile robots, robotic manipulators, humanoid robots, quadruped robots, autonomous vehicles, drones, industrial robots, service robots, wearable robotic systems, and other physically embodied artificial intelligence systems.

A robot may receive a verbal instruction directing the robot to perform a mission or physical action. Example instructions may direct the robot to navigate to a destination, retrieve or deliver an object, manipulate an item, assist a person, inspect an environment, use a tool, interact with infrastructure, or perform a sequence of related physical tasks.

To process the verbal instruction, the robot may execute one or more neural-network inference processes. The inference processes may employ a language model, vision-language model, vision-language-action model, world model, generative video model, predictive dynamics model, reinforcement-learning policy, diffusion policy, motion-planning model, action-generation model, or another model that generates or evaluates robot missions, candidate physical actions, trajectories, simulated futures, or predicted physical outcomes.

During inference, the robot or a cooperating execution resource may maintain in-progress model state. The in-progress model state may include latent tensors, visual feature state, temporal history state, attention state, key-value cache state, scheduler state, world-model state, predicted scene state, motion state, candidate-action state, mission-planning state, branch state, or other intermediate state generated before completion of the inference operation.

A person may provide a further verbal instruction while the inference operation is in progress. The further verbal instruction may modify, clarify, constrain, supplement, or supersede at least part of the original instruction. For example, while a robot is planning to retrieve an object, the person may state “use the other container,” “do not enter that room,” “take the safer route,” “give it to the person on the left,” or “place it on the lower shelf instead.”

The further verbal instruction may affect only part of the mission or candidate physical action. A change in a destination may leave object identity, environmental geometry, and an already completed route segment unchanged. A change in a manipulation instruction may leave navigation state unchanged. A newly identified safety constraint may affect one candidate trajectory while leaving perception and mission-purpose state valid.

Conventional robot systems may respond to a changed verbal instruction by terminating the active inference operation and initiating a new inference operation from an initial state. Such restarting may require the robot to reprocess sensor data, reconstruct environmental context, regenerate prior mission state, recompute a world-model representation, regenerate a complete trajectory, or repeat model operations whose results remain valid. Full restarting can increase response latency, consume additional processor and memory resources, increase power and thermal burden, and delay execution of a time-sensitive correction.

Other robot systems may append the further verbal instruction to an existing prompt or task history without determining which portions of active inference state depend on the prior instruction. Such operation can retain stale or inconsistent mission assumptions, simulated futures, planning outputs, or candidate-action state. A robot may therefore continue to prepare or execute a physical action that was generated from an instruction that has been modified or superseded.

Conversational barge-in mechanisms generally stop or truncate generated speech and initiate a new conversational response. Such systems do not adequately address preservation and selective revision of neural-network state used to control a physical robot. In particular, dialogue-level interruption does not determine which portions of robot mission state, world-model state, action-generation state, or motion-planning state remain valid following a changed instruction.

Likewise, conventional robot replanning techniques may respond to a changed goal or newly detected obstacle, but often do not coordinate verbal interruption with state-preserving continuation of active model inference. Such systems may not identify an interrupt-safe inference boundary, preserve unaffected model state, generate an updated branch context from the verbal instruction, invalidate only instruction-dependent state, and use the resulting updated inference to change a robot mission or candidate physical action before physical execution.

Accordingly, there is a need for a robust robot inference architecture that receives a verbal interruption during an in-progress inference operation associated with a robot mission or candidate physical action.

### SUMMARY

The present disclosure addresses these shortcomings with systems, methods, and computer program products for state-preserving verbal interruption of in-progress inference used for robot mission and action control.

In one embodiment, a physical AI device includes one or more sensors, one or more actuators, one or more processors, memory, an inference engine, and an inference-interruption controller. The inference engine performs an in-progress inference operation associated with a robot mission or candidate physical action while maintaining in-progress inference state associated with a current conditioning context.

During the in-progress inference operation, the inference-interruption controller receives a verbal interruption comprising a speech-derived instruction that changes at least a portion of the mission or candidate physical action. The controller generates an updated branch context, determines affected and unaffected portions of the in-progress inference state, preserves the unaffected portion, and selectively invalidates, revises, or recomputes the affected portion.

The inference engine resumes using the preserved unaffected state and the updated affected state without restarting from an initial inference state. An updated inference result modifies the robot mission, candidate physical action, route, trajectory, manipulation plan, or other physical behavior before corresponding actuator execution.

In some embodiments, the controller identifies an interrupt-safe computational boundary after completion of an issued model operation and before dispatch of a dependent operation. The system snapshots model state and execution-context metadata, including branch lineage, scheduler position, cache state, memory residency, dependency information, and validity indicators.

In some embodiments, the in-progress inference operation includes predictive world-model inference that generates a simulated future associated with a candidate physical action. The speech-derived instruction modifies the simulated future, and the robot uses the revised simulated future to update mission planning, motion planning, predictive validation, or action authorization.

In some embodiments, a candidate action generated before the verbal interruption is withheld, revoked, superseded, modified, or revalidated. The system may preserve a committed safety-critical action portion until a safe physical interruption point and revise a later action portion.

In some embodiments, preserved inference state and execution-context metadata are organized into an interrupt-resumption package transferable between onboard, edge, and remote execution resources. The receiving resource reconstructs a branch-consistent inference state and continues the robot mission or action inference without full recomputation.

Advantageously, the disclosed architecture reduces latency, memory traffic, repeated sensor processing, and wasted computation while improving robot responsiveness, mission continuity, physical safety, and consistency between revised human intent and physical action.

Many variations are possible.

### BRIEF DESCRIPTION OF THE DRAWINGS

The present disclosure will be understood more fully from the detailed description given below and from the accompanying drawings of various embodiments of the disclosure.

FIG. 1 is a block diagram illustrating an overall robotic system for processing verbal interruptions received during in-progress inference operations, according to an embodiment.

FIG. 2 is a more detailed block diagram illustrating the inference-interruption controller of FIG. 1, according to an embodiment.

FIG. 3 is a sequence diagram illustrating interactions among components of FIG. 1, according to an embodiment.

FIG. 4 is a block diagram illustrating a robot computing environment, according to an embodiment.

FIG. 5 is a flow diagram illustrating an overall method for verbally interrupting an in-progress inference operation and modifying a robot mission or candidate physical action while preserving unaffected inference state, according to an embodiment.

FIG. 6 is a flow diagram illustrating a method for identifying an interrupt-safe inference boundary, preserving reusable state, selectively revising affected state, and resuming robot inference from the revised state, according to an embodiment.

FIG. 7 is a flow diagram illustrating a method for modifying or revoking a candidate physical action based on an updated inference result before actuator execution, according to an embodiment.

### DETAILED DESCRIPTION

The following description provides systems, methods, and computer program products for state-preserving verbal interruption of in-progress robot inference. The described embodiments are illustrative and not limiting. Features described with respect to one embodiment may be combined with features of another embodiment unless context indicates otherwise. Like reference numerals may refer to like or functionally related elements throughout the drawings.

As used herein, a “robot” includes any physically embodied artificial intelligence platform having one or more actuators capable of affecting a real-world environment. A “verbal interruption” includes live speech, transcribed speech, recognized speech intent, remote operator speech, synthetic speech, an AI-generated voice signal, a speech-derived token sequence, or a semantic instruction object derived from speech. An “inference state” includes any intermediate or persistent state used to continue an inference operation, including key-value cache state, attention state, latent tensors, world-model state, scheduler state, mission state, planning state, candidate-action state, or combinations thereof.

As used herein, an “interruption instruction” broadly refers to any information received during an in-progress inference operation that changes, supplements, constrains, cancels, pauses, resumes, redirects, or otherwise modifies at least a portion of a current conditioning context, mission, candidate physical action, predicted future, world-model state, simulator state, or planning state. An interruption instruction may comprise one or more of speech, recognized speech intent, text, typed commands, graphical user-interface selections, gesture input, gaze input, haptic input, joystick input, wearable-device input, application programming interface (API) commands, supervisory artificial intelligence instructions, planner-generated instructions, robot-to-robot messages, sensor-derived events, policy updates, autonomous safety events, network-delivered commands, semantic instruction objects, or combinations thereof.

### I. SYSTEMS

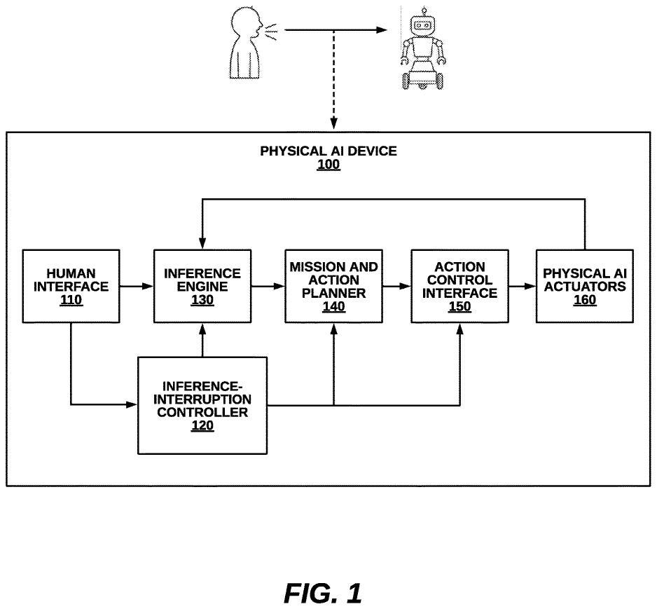

### A. Overall Robotic System for Verbal Inference Interruption (FIG. 1)

FIG. 1 illustrates an overall robotic system in which a verbal interruption received during an in-progress inference operation is used to update a robot mission or candidate physical action while preserving reusable inference state. The system includes a physical AI device 100, a human interface 110, an inference-interruption controller 120, an inference engine 130, a mission and action control system 140, action-control interface 150 and a physical AI actuators 160.

The physical AI device 100 may be a mobile robot, robotic arm, service robot, warehouse robot, delivery robot, quadruped, drone, autonomous vehicle, humanoid robot, wearable robotic system, industrial machine, or another physical AI platform. The physical AI device 100 may operate independently, as part of a fleet, under remote supervision, or in cooperation with other robots.

The human interface 110 may include a microphone, speech-recognition interface, speaker, display, remote teleoperation terminal, wearable device, smartphone, vehicle console, robot console, or networked human-machine interface. The interface 110 receives an original instruction and a subsequent verbal interruption. The subsequent instruction may change a target, object, destination, route, recipient, timing condition, safety constraint, manipulation strategy, physical-action parameter, or mission-completion condition.

Although many embodiments are described with respect to verbal interruptions, the human interface 110 may additionally or alternatively receive non-verbal interruption instructions. For example, an interruption instruction may be generated from a touchscreen selection, keyboard input, gesture-recognition system, eye-tracking system, wearable device, joystick, supervisory software process, API request, another robot, fleet-management system, safety monitor, policy engine, or another human-machine interface. Such interruption instructions may be converted into semantic instruction objects that are processed by the inference-interruption controller in substantially the same manner as speech-derived instructions.

The inference-interruption controller 120 can be logically coupled to the human interface 110, inference engine 130, and mission and action control system 140. In an embodiment, the controller 120 detects the verbal interruption, generates an updated branch context, analyzes state dependencies, preserves unaffected state, selectively invalidates or updates affected state, and coordinates resumption of the inference operation.

The inference engine 130, in an embodiment, performs an in-progress inference operation using a current conditioning context. The engine 130 may execute a language model, vision-language model, vision-language-action model, predictive world model, generative video model, diffusion model, reinforcement-learning policy, learned dynamics model, route model, mission model, motion model, multimodal transformer, or hybrid architecture. The inference operation may generate or evaluate a robot mission, mission subtask, route, candidate physical action, simulated future, trajectory, grasp plan, tool-use sequence, object interaction, human interaction, action token, or other physical behavior. In some embodiments, a plurality of inference models cooperate in a pipeline, and the verbal interruption affects state maintained by more than one model or planner.

The mission and action control system 140 may include a mission planner, task planner, route planner, behavior planner, motion planner, action generator, predictive validator, policy engine, actuator firewall, release-token authority, or action-authorization controller. The system 140 receives an updated inference result and modifies at least one of the mission or candidate physical action before physical execution.

The physical AI device 100 may include sensors, processors, memory, communication interfaces, and physical AI actuators 160. The sensors may include cameras, depth sensors, lidar, radar, microphones, inertial sensors, tactile sensors, force-torque sensors, encoders, localization sensors, environmental sensors, or combinations thereof. The physical AI actuators 160 may include motors, servos, grippers, brakes, propulsion devices, valves, tools, steering devices, or other electromechanical endpoints. Responsive to an updated inference result received through the action-control interface 150, the physical AI actuators 160 may perform one or more modified real-world actions. In one example, a person instructs the robot to retrieve a blue container. While the inference engine 130 is generating a route and grasp plan, the person states, “Use the red container instead.” The controller 120 preserves scene geometry, robot location, recognized shelf structure, and completed route-prefix state, while revising object identity, final route segment, grasp plan, world-model outcome, and candidate-action state. In another example, the person states, “Do not enter that room,” while the robot is generating a navigation mission. The controller 120 preserves the mission purpose and valid map state, invalidates a route segment that enters the room, generates an updated route constraint, and resumes planning from preserved route and environmental state.

In another example, a user selects a different destination on a touchscreen while the robot is generating a navigation plan. In another embodiment, a fleet-management system transmits an updated delivery priority through an API. In another embodiment, a safety monitor detects a hazardous condition and automatically generates an interruption instruction that modifies a route or candidate physical action. In another embodiment, another robot communicates updated shared-world-model information causing revision of a predicted future. In each case, the inference-interruption controller preserves unaffected inference state, selectively updates affected inference state, and resumes inference without restarting from an initial inference state.

In some embodiments, the verbal interruption is received before physical execution. In other embodiments, a multi-part physical action has begun, and the system preserves a committed or safety-critical action portion while revising a later unexecuted portion. A safe physical interruption point may be selected according to velocity, contact, balance, load, environmental risk, or actuator state.

As used herein, “interaction-centric artificial intelligence” refers to artificial intelligence in which generation, evaluation, prediction, interruption, preservation, branching, selection, modification, resumption, or execution of an inference is responsive to an interaction with one or more humans, robots, software agents, infrastructure systems, environmental systems, or other entities. An interaction can be verbal, textual, visual, gestural, physical, social, collaborative, corrective, instructional, clarifying, authorizing, prohibiting, or otherwise communicative. Interaction-centric artificial intelligence can be implemented using one or more language models, vision-language models, vision-language-action models, interaction models, world models, policy models, planning models, motion models, or other learned, deterministic, or hybrid processes. In an embodiment, the interaction occurs during generation of an active inference and causes the active inference to be interrupted, modified, redirected, branched, or resumed from preserved reusable inference state.

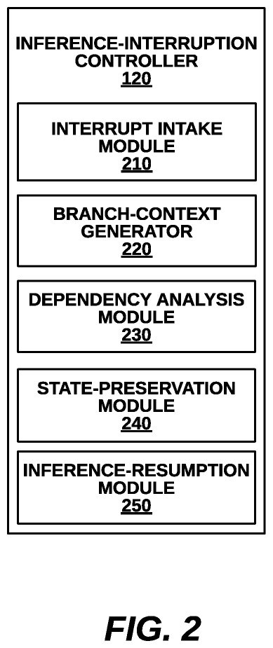

### B. Inference-Interruption Controller (FIG. 2)

FIG. 2 illustrates the inference-interruption controller 120 in greater detail. The controller 120 includes an interrupt intake module 210, branch-context generator 220, dependency analysis module 230, state-preservation module 240, and inference-resumption module 250.

The interrupt intake module 210 receives speech or a speech-derived instruction during active inference. The module may determine whether speech is directed to the robot, whether the speaker is authorized, whether the instruction modifies the current mission, whether the instruction constitutes a new mission, urgency, safety priority, and whether immediate interruption is required.

In some embodiments, the interrupt intake module 210 receives interruption instructions from non-speech sources. Such interruption instructions may include typed commands, graphical user-interface events, application programming interface calls, supervisory AI outputs, planner-generated updates, policy modifications, robot-to-robot communications, sensor-triggered events, or autonomous safety conditions. The interrupt intake module may normalize such inputs into a common interruption representation prior to dependency analysis and branch generation.

The interrupt intake module 210 may classify the speech as ordinary conversation, mission modification, mission cancellation, action correction, route modification, target substitution, safety override, emergency stop, or a new independent request. A confidence score may be generated, and low-confidence speech may cause a clarification response, conservative hold state, or human-confirmation request.

The branch-context generator 220 converts the verbal interruption into an updated branch context. The branch context may include revised tokens, embeddings, semantic intent, object identifiers, target identifiers, person identifiers, location identifiers, route constraints, motion constraints, policy directives, temporal conditions, action parameters, masks, control vectors, or multimodal fused state.

The updated branch context need not originate from speech. Any interruption instruction capable of modifying semantic intent, planning objectives, environmental assumptions, safety constraints, mission state, physical parameters, or execution policies may generate an updated branch context. Consequently, the disclosed state-preservation architecture operates independently of the modality by which updated intent is received.

The branch-context generator 220 may compare the speech-derived instruction with the current conditioning context to identify added, deleted, changed, or superseded semantic elements. The generated branch context may preserve unchanged instruction elements while replacing only a changed target, route, physical constraint, object, person, timing condition, or action parameter.

The dependency analysis module 230 determines which portions of the in-progress inference state depend on the superseded conditioning context. Dependency representations may include dependency graphs, lineage graphs, attention maps, state masks, branch trees, token ranges, temporal segments, spatial regions, latent subspaces, layer dependencies, planner-state dependencies, or combinations thereof.

The dependency analysis module 230 separates affected state from unaffected state. Affected state may include target-specific visual grounding, downstream mission nodes, a future route suffix, a predicted object interaction, a motion trajectory, a grasp plan, a candidate action, validator output, or execution authorization. Unaffected state may include stable scene geometry, current robot pose, completed mission nodes, map state, unaffected object identities, and branch-independent model state.

The state-preservation module 240 preserves reusable inference state in one or more protected memory regions. Preserved state may include KV-cache pages, latent tensors, feature maps, attention state, world-model state, scheduler state, branch lineage, visual grounding state, mission state, route-prefix state, completed action state, model weights, and memory-residency information.

The state-preservation module 240 may use snapshotting, copy-on-write, reference counting, shared-prefix state, branch deltas, versioned state objects, protected cache partitions, dedicated HBM pages, on-chip state stores, shadow buffers, or other preservation mechanisms. A validity map may identify state portions that remain usable after the interruption.

The inference-resumption module 250 applies the updated branch context, recomputes affected state, merges recomputed state with preserved state, and resumes inference. Resumption may occur without restarting the model from an initial state, reprocessing all sensor data, flushing unaffected cache state, or regenerating completed mission portions.

In some embodiments, multiple verbal interruptions are received during a same mission. The controller 120 may queue, prioritize, merge, or supersede interrupts and maintain branch lineage identifiers for successive revised states. Safety-critical instructions may receive priority over ordinary mission refinements.

### C. Inference, State Preservation, and Physical-Action Processing

The inference engine 130, mission and action control system 140, action-control interface 150, and physical AI actuators 160 may cooperate as separate modules, integrated model portions, cooperating processes, or distributed services. The inference engine 130 may include one or more multimodal inference models, mission models, predictive world models, learned dynamics models, physics simulators, motion models, action-generation models, or combinations thereof.

The inference engine 130 may receive speech, text, images, video, depth data, tactile data, force data, localization, prior mission context, object information, human-interaction information, or other sensor and semantic inputs. The inference engine 130 may interpret an instruction, ground verbal references, identify task-relevant entities, and generate mission, simulation, planning, or action representations.

A mission planner, task planner, route planner, or behavior planner of the mission and action control system 140 may generate mission goals, subtasks, ordering, resource assignments, target locations, timing conditions, and completion conditions. An interruption may modify one mission node while preserving unaffected mission nodes and their associated state.

A predictive world model, learned dynamics model, physics simulator, or digital twin executed by the inference engine 130 or mission and action control system 140 may generate predicted future observations, generated video, latent future states, scene-state trajectories, object movement, human movement, contact outcomes, collision risk, action consequences, or task outcomes. A predicted future need not be rendered as visible video and may be represented by tensors, tokens, graphs, occupancy structures, trajectories, scene-state objects, or combinations thereof.

In some embodiments, the predictive model or simulator generates consequences of a candidate physical action while an interruption is received. The inference-interruption controller 120 preserves stable scene and robot state, changes a conditioning input according to the interruption, selectively regenerates an affected temporal, semantic, or physical portion of the predicted future, and provides the revised future to the mission and action control system 140.

In some embodiments, the interruption modifies not only an output of a predictive model, but also one or more parameters, boundary conditions, physical-property values, environmental conditions, contact assumptions, object properties, actuator constraints, or solver settings used by a physics simulator, learned dynamics model, digital twin, or predictive world model. For example, the interruption may identify or modify gravity, friction, mass, center of mass, compliance, restitution, terrain condition, surface condition, payload, contact geometry, actuator capability, force limit, velocity limit, human-motion assumption, collision geometry, or another physical simulation condition. The inference-interruption controller 120 may preserve an unaffected portion of an in-progress simulation state, selectively invalidate or revise simulator state dependent on the modified condition, and resume simulation from the preserved and revised state without restarting from an initial simulation state.

In some embodiments, the updated inference result comprises an updated simulator configuration, physics-simulation state, digital-twin state, learned-dynamics state, or simulated environment rather than an immediately updated mission or motion plan. The updated simulator configuration or simulation state may thereafter be used for mission planning, motion planning, candidate-action generation, predictive validation, training, policy evaluation, digital-twin synchronization, or generation of one or more revised predicted physical outcomes.

A motion or action planner of the mission and action control system 140 may generate route segments, trajectories, grasp plans, actuator sequences, movement primitives, action tokens, force profiles, tool-use sequences, or staged candidate actions. The planner may preserve an unaffected trajectory prefix or unaffected subtask and regenerate an affected suffix or sub-trajectory.

The mission and action control system 140 or physical AI actuators 160 may release, withhold, revoke, modify, delay, decompose, reroute, or submit a candidate action for predictive validation. In some embodiments, an action-control interface communicates with an actuator firewall or hardware-enforced controller that accepts only an action accompanied by a currently valid release authorization.

The inference-interruption controller 120 may propagate an interruption through multiple processing levels. For example, changing a delivery recipient may update language grounding, mission state, world-model state, route planning, handoff planning, predictive validation, and action authorization while preserving current location, carried-object identity, and completed route state.

In some embodiments, each model, planner, state object, or candidate action maintains a version identifier or branch identifier. When an interruption occurs, downstream state objects derived from a superseded version are invalidated, and only state objects derived from the updated branch context are eligible to control physical execution.

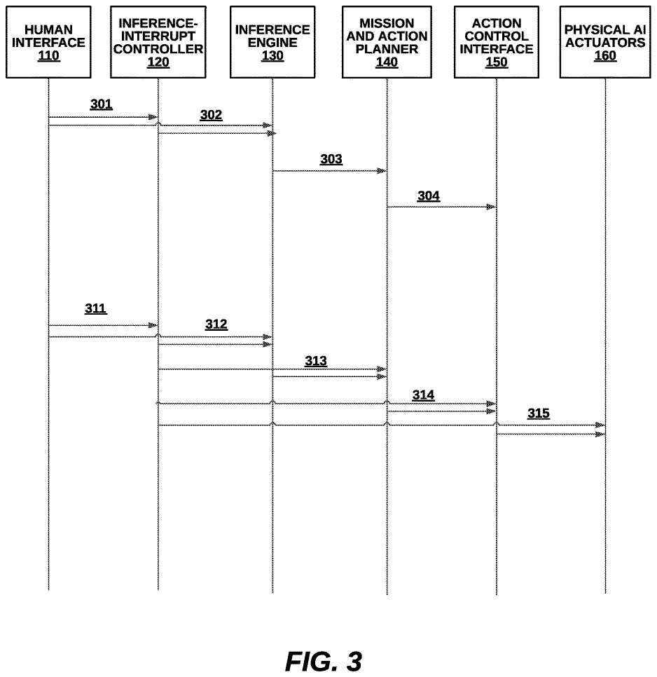

### D. Interruption Sequence (FIG. 3)

FIG. 3 illustrates an example sequence among components of FIG. 1, including the human interface 110, inference-interruption controller 120, inference engine 130, mission and action planner 140, action-control interface 150, and physical AI actuators 160.

At 301, the human interface 110 receives an initial instruction and provides the instruction to the inference engine 130 or inference-interruption controller 120. At 302-304, the inference engine 130 begins an in-progress inference operation for a robot mission, simulated future, motion plan, candidate physical action, physical action, or combination thereof. The final necessary step is to instruct actuators. However, plans are updated at any of 302, 303, or 304 by the interrupt.

At 311, before completion of the in-progress inference operation, the human interface 110 receives a verbal interruption or other updated instruction and provides an interruption signal to the inference-interruption controller 120. The controller 120 detects the interruption, identifies an interrupt-safe boundary, and generates an updated branch context.

At 312, the inference-interruption controller 120 determines affected and unaffected portions of the in-progress inference state. The controller 120 preserves reusable state, invalidates or revises instruction-dependent state, and causes the inference engine 130 to resume using preserved and updated state without restarting from an initial inference state.

At 313 through 315, the resumed inference operation may generate an updated mission, predicted future, simulator configuration, route, trajectory, manipulation plan, candidate physical action, validation result, or authorization state. The mission and action control system 140 receives the updated inference result and generates or selects a corresponding updated physical action.

The mission and action control system 140 determines whether a prior candidate physical action depends on affected inference state. If so, prior execution authority may be withheld, revoked, or superseded. The updated action may be predictively validated and provided to the physical AI actuators 160 through action-control interface 150 only after the updated state is committed.

In some embodiments, the system maintains an interruption ledger recording the original instruction, updated instruction, speaker or source identity, affected state classes, preserved state classes, branch lineage, revoked action identifier, updated action identifier, validation outcome, and execution result.

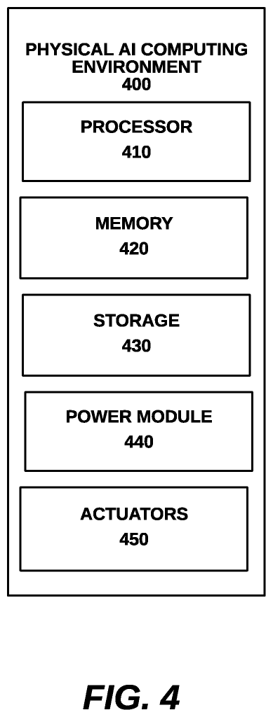

### E. Computing Environment and Distributed Execution (FIG. 4)

FIG. 4 illustrates a robot/physical AI computing environment 400 including a processor 410, memory 420, storage 430, power module 440, and actuators 450, each communicatively coupled over one or more buses or interconnects.

The processor 410 may include one or more CPUs, GPUs, NPUs, TPUs, FPGAs, ASICs, AI accelerators, motor-control processors, service processors, or distributed processing resources. The memory 420 may include SRAM, cache, HBM, DRAM, unified memory, persistent memory, accelerator memory, or remote memory.

An input/output interface may receive speech, text, gestures, images, controller input, sensor data, or other multimodal input. The robot actuator controller may communicate with motor drivers, servo controllers, gripper controllers, brake controllers, propulsion controllers, tool controllers, or other physical execution endpoints.

The in-progress inference operation may execute entirely onboard the robot, at an edge server, in a data center, or across multiple tiers. Latency-sensitive or safety-critical state may remain onboard while compute-intensive world-model or planning operations execute remotely.

In some embodiments, the state-preservation module forms an interrupt-resumption package including preserved inference state, updated branch context, dependency information, branch lineage, scheduler position, model-version information, robot-state information, and compatibility metadata. The package may be transferred to another execution resource for continuation.

The receiving resource may reconstruct a branch-consistent state, reference a shared-prefix state, load branch-specific state, and continue inference without recomputing the complete initial context. Current robot sensor state may be supplied to the receiving resource to update stale environmental portions before continuation.

A routing controller may select an execution resource according to latency, memory pressure, thermal state, battery state, network condition, privacy policy, model compatibility, action criticality, expected recomputation cost, or availability of specialized robotics models.

If network communication becomes unavailable, the system may resume from preserved local state using a smaller local model, reduce mission scope, maintain a safe hold state, or execute a locally validated fallback action.

### II. Methods

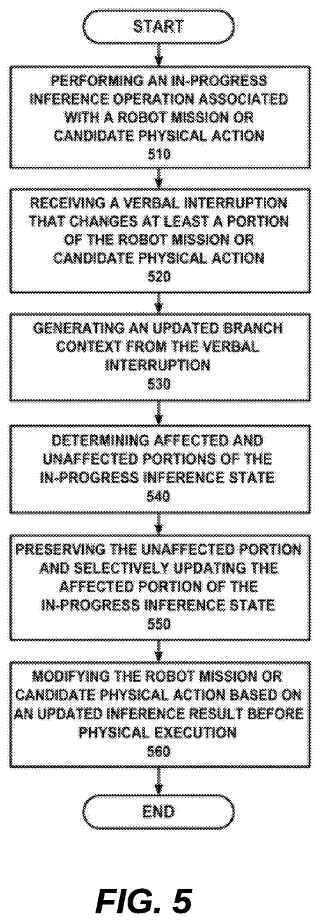

### A. Overall Method for State-Preserving Verbal Interruption (FIG. 5)

Referring to FIG. 5, at step 510, performing an in-progress inference operation associated with a robot mission or candidate physical action. The inference operation maintains in-progress inference state associated with a current conditioning context.

At step 520, receiving a verbal interruption that changes at least a portion of the robot mission or candidate physical action. The verbal interruption is received before completion of the inference operation or before execution of an affected physical-action portion.

At step 530, generating an updated branch context from the verbal interruption. The updated branch context may identify changed mission, object, person, location, route, action, timing, policy, force, speed, or constraint information.

At step 540, determining affected and unaffected portions of the in-progress inference state. The determination may use dependency, lineage, attention, branch, temporal, spatial, semantic, planning, mission, or action information.

At step 550, preserving the unaffected portion and selectively updating the affected portion of the in-progress inference state. The update may include invalidation, partial recomputation, replacement, branch-state revision, or regeneration of an affected simulated future.

At step 560, modifying the robot mission or candidate physical action based on an updated inference result before physical execution. The corresponding action may be released, denied, modified, delayed, decomposed, rerouted, or revalidated.

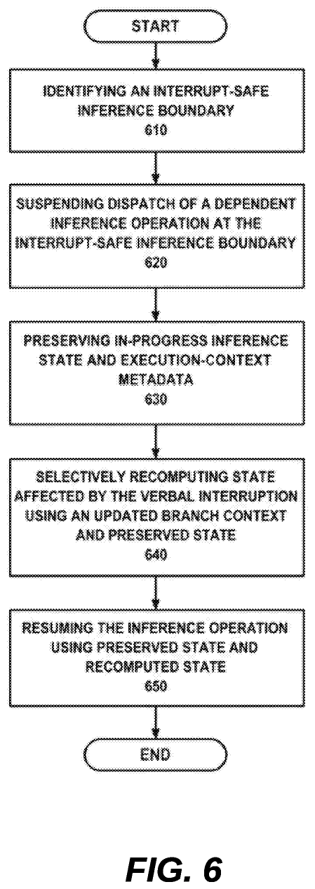

### B. Interrupt-Safe State Preservation and Inference Resumption (FIG. 6)

Referring to FIG. 6, at step 610, identifying an interrupt-safe inference boundary. The boundary may occur between model blocks, decoding operations, denoising steps, planner stages, action-generation stages, world-model rollout segments, tensor-operation groups, or memory-consistency points.

At step 620, suspending dispatch of a dependent inference operation at the interrupt-safe inference boundary. Already-issued operations may be allowed to complete and commit valid results.

At step 630, preserving in-progress inference state and execution-context metadata. The metadata may identify valid state, affected state, model position, scheduler state, branch lineage, memory location, dependency information, and robot-state version.

At step 640, selectively recomputing state affected by the verbal interruption using an updated branch context and preserved state. The recomputation is less than a full restart of the inference operation.

At step 650, resuming the inference operation using preserved state and recomputed state. The inference engine continues from a revised branch-consistent state without reprocessing an entirety of the original instruction or sensor context.

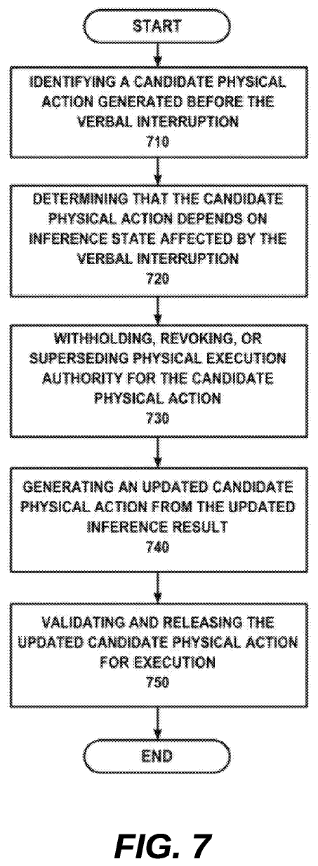

### C. Physical-Action Revision and Authorization (FIG. 7)

Referring to FIG. 7, at step 710, identifying a candidate physical action generated before the verbal interruption. The candidate action may be pending, planned, predicted, validated, authorized, queued, or partially executing.

At step 720, determining that the candidate physical action depends on inference state affected by the verbal interruption. The dependency may concern an object, person, route, trajectory, mission goal, physical constraint, predicted result, policy state, or authorization state.

At step 730, withholding, revoking, or superseding physical execution authority for the candidate physical action. This prevents execution based on stale inference state.

At step 740, generating an updated candidate physical action from the updated inference result. The updated action may be a modified version of the prior action or a different action selected from a revised mission or world-model result.

At step 750, validating and releasing the updated candidate physical action for execution. Validation may include collision checking, world-model prediction, safety evaluation, policy evaluation, feasibility evaluation, human-clearance evaluation, or authorization-token generation.

### III. Generalities

The functions described herein may be implemented in hardware, software, firmware, microcode, or combinations thereof. Components described as separate may be combined, and functions described as a single component may be distributed among multiple processors, devices, or execution tiers.

The interruption instruction may originate from a nearby human, remote operator, owner, fleet supervisor, safety monitor, another robot, artificial intelligence supervisor, synthetic voice source, network-delivered process, application programming interface, graphical user interface, gesture-recognition system, gaze-recognition system, wearable device, policy engine, planner, autonomous software process, or other human or machine source. The interruption instruction may be verbal or non-verbal. Where the interruption originates from a human, speaker identity or user authority may be verified before application. Where the interruption originates from another machine or software process, source identity, authentication, authorization, trust level, or policy compliance may likewise be verified before the interruption is applied. The updated instruction may modify, supplement, constrain, cancel, pause, revoke, or supersede an earlier instruction. It may affect an entire mission or only a mission node, route segment, object interaction, temporal condition, model branch, motion segment, actuator group, or authorization.

Affected and unaffected state may be identified at token, tensor, layer, cache-page, branch, temporal, spatial, semantic, planning, mission, action, or actuator granularity. State preservation may use snapshots, copy-on-write, shared prefixes, deltas, references, versioning, protected memory, persistent objects, or branch-specific state objects.

The inference state may include KV-cache state but is not limited to transformer KV caches. It may include recurrent state, state-space model state, diffusion state, latent scene state, graph state, world-model state, visual grounding, route state, mission state, action tokens, motion-planner state, validator state, or authorization state.

The predicted future may be represented as video frames, latent video, predicted observations, scene graphs, occupancy state, physical-state trajectories, action-conditioned tokens, dynamics state, or any temporally linked representation of expected physical consequences.

In some embodiments, the robot reaches a safe physical interruption point before applying an updated action. The system may preserve a committed balance, contact, braking, load-bearing, or other safety-critical action portion while revising an uncommitted portion.

A prior action may be revoked after predictive validation or authorization but before actuator execution. A new validation result or release authorization may be required for the updated action. Validation and authorization records may be stored for audit, replay, training, certification, or incident reconstruction.

The disclosed techniques may be practiced with one model or multiple cooperating models, locally or remotely, and with centralized, distributed, fleet, or peer-assisted robot architectures. Features described for a mission may apply to a candidate physical action and vice versa.

The steps of the disclosed methods may be performed in different orders, combined, repeated, omitted, or performed concurrently. Additional steps may be included without departing from the scope of the disclosure.

A non-transitory computer-readable medium may store instructions that, when executed by one or more processors or controllers, cause performance of any of the operations described herein.

The foregoing description is illustrative and is not intended to limit the invention to the precise forms disclosed. The scope of the invention is defined by the appended claims and their equivalents.

I claim:

1. A physical artificial intelligence (AI) system comprising:
a physical AI comprising one or more sensors, one or more actuators, one or more processors, and memory;
an inference engine configured to perform an in-progress inference operation associated with at least one of a mission or a candidate physical action of the physical AI while maintaining in the memory an in-progress inference state associated with a current conditioning context; and
an inference-interruption controller configured to:
receive, during the in-progress inference operation, an interruption that changes at least a portion of the mission or the candidate physical action;
generate, from the speech-derived instruction, an updated branch context for the in-progress inference operation;
determine, based on a dependency relationship between the current conditioning context and the updated branch context, an affected portion and an unaffected portion of the in-progress inference state;
preserve the unaffected portion of the in-progress inference state;
selectively invalidate or update the affected portion of the in-progress inference state using the updated branch context;
resume the in-progress inference operation using the preserved unaffected portion and the updated affected portion without restarting the inference operation from an initial inference state;
generate an updated inference result associated with the mission or the candidate physical action; and
cause the physical AI to modify at least one of the mission or the candidate physical action based on the updated inference result before execution of a corresponding physical action by the one or more actuators.

2. The physical AI system of claim 1, wherein the inference engine comprises at least one of a language model, vision-language model, vision-language-action model, predictive world model, generative video model, diffusion model, reinforcement-learning policy, learned dynamics model, mission model, route model, or motion-planning model.

3. The physical AI system of claim 1, wherein the in-progress inference state comprises at least one of a key-value cache state, attention state, latent tensor, visual feature state, temporal history state, scheduler state, world-model state, mission-planning state, route state, motion-planning state, candidate-action state, or branch-lineage state.

4. The physical AI system of claim 1, wherein the dependency relationship is represented by at least one of a dependency graph, lineage graph, attention map, state mask, branch tree, token range, temporal segment, spatial region, latent subspace, model-layer dependency, or planner-state dependency.

5. The physical AI system of claim 1, wherein the inference-interruption controller is further configured to identify an interrupt-safe inference boundary, suspend dispatch of a dependent inference operation at the interrupt-safe inference boundary, and preserve execution-context metadata identifying a resumable position of the in-progress inference operation.

6. The physical AI system of claim 1, wherein the unaffected portion comprises at least one of stable scene geometry, current robot pose, recognized object state, recognized person state, completed mission state, route-prefix state, persistent world-model state, or branch-independent model state.

7. The physical AI system of claim 1, wherein the inference engine comprises a predictive world model configured to generate a simulated future associated with the candidate physical action, and wherein the updated inference result comprises a revised simulated future generated by preserving an unaffected portion of the simulated future and recomputing an affected portion of the simulated future.

8. The physical AI system of claim 1, wherein the inference-interruption controller is configured to preserve the unaffected portion using at least one of snapshotting, copy-on-write, reference counting, shared-prefix state, branch-delta state, state-object versioning, a protected cache partition, or dedicated state-preservation memory.

9. The physical AI system of claim 1, further comprising an action-control interface configured to withhold, revoke, or supersede execution authority for a pre-interruption candidate physical action determined to depend on the affected portion of the in-progress inference state.

10. The physical AI system of claim 9, wherein the action-control interface is further configured to cause predictive validation of an updated candidate physical action and release the updated candidate physical action only responsive to satisfaction of at least one physical-safety or mission-consistency criterion.

11. The physical AI system of claim 1, wherein the interruption comprises a verbal interruption from a human.

12. A computer-implemented method comprising:
performing an in-progress inference operation associated with at least one of a robot mission or a candidate physical action while maintaining in-progress inference state associated with a current conditioning context;
receiving, before completion of the in-progress inference operation, an interruption that changes at least a portion of the robot mission or the candidate physical action;
generating an updated branch context from the speech-derived instruction;
determining an affected portion and an unaffected portion of the in-progress inference state;
preserving the unaffected portion of the in-progress inference state;
selectively updating the affected portion of the in-progress inference state using the updated branch context;
resuming the in-progress inference operation using the preserved unaffected portion and the updated affected portion without restarting from an initial inference state; and
modifying the robot mission or the candidate physical action based on an updated inference result before physical execution of an action corresponding thereto.

13. The method of claim 12, further comprising identifying an interrupt-safe inference boundary and snapshotting the in-progress inference state and execution-context metadata at the interrupt-safe inference boundary.

14. The method of claim 12, wherein selectively updating the affected portion comprises recomputing fewer than all model operations that would be performed during a full restart of the in-progress inference operation.

15. The method of claim 12, wherein modifying the candidate physical action comprises preserving a committed safety-critical action portion until the physical AI reaches a safe physical interruption point and revising a later unexecuted action portion.

16. The method of claim 12, further comprising revoking an authorization associated with a pre-interruption candidate physical action and generating a new authorization associated with an updated candidate physical action.

17. The method of claim 12, wherein the interruption changes at least one of a target object, target person, destination, route, action parameter, force constraint, speed constraint, timing condition, safety constraint, or mission-completion condition.

18. The method of claim 12, wherein the in-progress inference operation comprises generating an action-conditioned predicted future, and wherein modifying the candidate physical action is based on a revised predicted future produced using the preserved unaffected portion and the updated affected portion.

19. A non-transitory computer-readable medium storing instructions that, when executed by one or more processors of a physical artificial intelligence (AI) system, cause the one or more processors to perform operations comprising:
maintaining in-progress inference state while performing an inference operation associated with a robot mission or candidate physical action;
receiving an interruption that changes at least a portion of the robot mission or candidate physical action;
generating an updated branch context from the speech-derived interruption;
preserving a portion of the in-progress inference state determined to remain valid;
updating another portion of the in-progress inference state determined to depend on a superseded conditioning context;
continuing the inference operation using the preserved portion and the updated portion without restarting from an initial inference state; and
causing modification of the robot mission or candidate physical action before execution by one or more actuators.

20. The non-transitory computer-readable medium of claim 19, wherein the operations further comprise preventing execution of a pre-interruption candidate physical action, generating an updated candidate physical action, and releasing the updated candidate physical action only after predictive validation against current robot and environmental state.
